(19) United States
(12) Patent Application Publication
(10) Pub. No.: US 2003/0037129 A1
(43) Pub. Date: Feb. 20, 2003

(54) Modular remote network policy management system

(75) Inventors: Mark A. Beadles, Hilliard, OH (US); William S. Emerick, Dublin, OH (US); Kevin A. Russo, Lewis Center, OH (US); Kenneth E. Mulh, Upper Arlington, OH (US); Raymond J. Bell, Mill Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Smartpipes, Incorporated, Redwood City, CA (US)

(21) Appl. No.: 10/219,142

(22) Filed: Aug. 13, 2002

Related U.S. Application Data
(60) Provisional application No. 60/312,499, filed on Aug. 14, 2001.

(51) Int. Cl. G06F 15/177

(52) U.S. Cl. 709/220

(57) ABSTRACT

A modular remote network management system which can configure a customer's network over the internet. A first module receives customer descriptions of desired customer network policy configurations. Another module automatically translates that description into device-level policy configuration data. Finally, a third module transmits the device-level policy configuration data over the internet to the devices of the customer network.

### CROSS-REFERENCE TO RELATED APPLICATIONS

This application is related to copending application Ser. No. ______, “Selection and Storage of Policies in Network Management” (Attorney Docket No. 20063P-001210US), Ser. No. ______, “Policy Engine for Modular Generation of Policy for a Flat, Per-Device Database” (Attorney Docket No. 20063P-00130US), Ser. No. ______, “Event Management for a Remote Network Policy Management System” (Attorney Docket No. 20063P-001410US) and Ser. No. ______, “Device Plug-in System for Configuring Network Devices over a Public Network” (Attorney Docket No. 20063P-001510US), all filed even date herewith and assigned to the same assignee, and all incorporated herein by reference.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to management and control of communication networks and, in particular, to remote management across the internet.

Networks

A communication network typically includes a number of network devices that, among other functions, transmit or receive data. A local area network, commonly referred to as a LAN, is a privately owned network that facilitates communication among the devices coupled to the network via one of several data communication protocols such as Ethernet or FDDI. Multiple LANs are typically interconnected via, for example, private links or satellite transmissions to form a wide area network, commonly referred to as a WAN. Such LANs and WANs are increasingly being coupled to the internet.

Communication network systems are becoming ever more complex. To increase resource sharing and facilitate their supervision, computer systems, such as facsimile machines, desktop computers, printers, etc. are typically coupled to a LAN. The complexity that arises as a result of increasing the number and the variety of systems, which in the aggregate form a computer network, coupled with the variety of communication protocols that such devices are required to support, increase the knowledge base that is often required to manage such networks. The problem is further compounded by the increasing complexity of new generation of high performance network devices and their interoperability as well as by the lack of qualified and well-trained network administrators. To operate and conform to a network's objectives, a network device (e.g. a router) is first configured—i.e., the networking parameters of the device are set to desired values. An inventory as well as a record of the configuration parameters of each configured networked device is typically maintained for future reference. Network devices are often reconfigured (e.g., by changing router ports, routing tables, IP addresses) to accommodate for network expansion or modification—for example, to add a new user to the network.

Device Based Network Management

One conventional method of configuring a networked device is to issue commands which are specific to the device via a computer system. A drawback of the method is that each networked device is configured and subsequently verified separately to ensure its confoinity with the desired network objectives. Another drawback of the method is that it requires an extensive knowledge base—of the various network device types—which may become prohibitively large as the number of device types in a network rises.

Outsourcing Network Management

Another known method for managing a communications network is through outsourcing the network management to another commercial entity. For example, WorldCom Inc., located at 500 Clinton Center Drive, Clinton Mass., 39056 offers a network management service based on which a group of network administrators at WorldCom, upon receiving specific requests to manage or configure a network device, transmit related commands and data via the internet to the network device thereby to manage or configure the device. The method, however, involves human intervention and is thus inefficient and unautomated.

Policy Based Network Management

A third known method for managing networked devices is to include a number of individual devices of a given type in a policy domain and apply a set of policies to the domain. Such policy-based methods, however, are only applicable to a limited number of specific device types. Furthermore, in such conventional policy-based network communication systems, policies are defined through a descriptive programming language. The applied policies so defined become attributes of their associated devices and are thus not objects which can be pointed to and thus viewed.

In directory-enabled policy-based network management systems, a directory serves as the central location for storing policies, profiles, user information, network configuration data, and internet protocol (IP) infrastructure data, such as network addresses and server information. Policies in directory-enabled networking (DEN) are defined in terms of rules containing conditions and actions for managing users, network resources, and services/applications.

In DEN, physical details of a network are separated from the logical attributes of the application types. DEN has many key attributes and characteristics that typically enable an associated network to be rapidly reconfigured and operate with other platforms. A directory-enabled network is typically scalable, fault-tolerant, and, preferably recognizes people and application by their associated attributes and characteristics and not by their numerical sequences, such as their IP addresses.

Data stored in the directory of a directory-enabled network are typically in formats derived from standard schemas based on the DEN specification published by a group of companies which are collectively known as the Distributed Management Task Force (DMTF). A schema is a collection of rules defining the relationships among objects representing users, applications, network elements, and network services. Each schema contains rules which govern the organization and logical representation of the schema objects.

Access to directory in DEN is commonly governed by version 3 of the known lightweight directory access protocol (LDAPv3), which is a stripped down version of the X.500 directory services standard.

In a directory-enabled network, network entities and the relationship between such network entities are governed by an information system, known in the art as the common information model (CIM). A CIM contains rules regarding management of, for example, hardware, operating systems, operations, application installation and configuration, security, identity, etc. The CIM which is also defined by the DMTF is a standard object-oriented model that represents objects in terms of instances, properties, relationships, classes and subclasses. A primary goal of the CIM is to present a consistent view of managed networks independent of the protocols and data formats supported by the various devices in and applications running on the networks.

One known directory serving as the central storage location in a directory-enabled network is the Windows 2000 Active Directory™, which is developed by and is available from Microsoft Corporation located at One Microsoft Way, Redmond, Wash., 98052. In addition to serving as the cental policy store, Windows 2000 Active Directory™ provides a framework for, among other function, publishing network services, managing users, computer systems, applications and services, as well as secure intranet and internet network services. Furthermore, Windows 2000 Active Directory™ provides a backbone for distributed security in Windows 2000 and a central service point for administrators to manage network services. Windows 2000 Active Directory™, which is an effective platform for DEN, is based on standard protocols such as Domain Name System (DNS)—which is used to locate servers running Active Directory—LDAPv3 (described briefly above) and Kerberos—which is a security protocol for logon authentication.

The Windows 2000 Active Directory™ includes a schema with definitions for every object class that exists in the directory service. Therefore, the universe of objects that may be represented in the Active Directory™ is extensible. Other information related to the Windows 2000 Active Directory™ features and functions are available from Microsoft corporation. The Active Directory supports Component Object Model (COM) features. COM is a language independent standard that promotes object oriented programming by specifying the interfaces of a component at the binary level.

As stated above, conventional methods of configuring and maintaining a communication network are costly, time-consuming and require expert administrators capable of reliably managing and controlling ever more complex network systems in a timely manner.

### BRIEF SUMMARY OF THE INVENTION

The present invention provides a modular remote network management system which can configure a customer's network over the internet. A first module receives customer descriptions of desired customer network policy configurations. Another module automatically translates that description into device-level policy configuration data (device-specific commands). Finally, a third module transmits the device-level policy configuration data over the internet to the devices of the customer network.

In one embodiment, the second module is a policy generator which generates non-device specific policies for each device. The third module is a device plug-in layer which translates the non-device specific policy into a device-specific policy. The device-specific policy is transmitted to the network device over the internet using a secure communication link. In one embodiment, that secure communication link is an IPSec tunnel. The network policy can include Virtual Private Network (VPN) policy.

In one embodiment, the non-device specific format is XML-based. The generation of the policy is done by separate policy service agents (PSAs) which specialize in a certain type of policy. For example, one PSA will produce VPN policy, while another PSA will generate Application Management Services (AMS) policy, and another PSA will generate security policy.

### BRIEF DESCRIPTION OF THE DRAWINGS

FIGS. 1A-1F show a client network communications system being managed by the policy-based network management system, in accordance with one embodiment of the present invention.

FIGS. 2A and 2B show various layers of the policy-based network management system of FIG. 1.

### DETAILED DESCRIPTION OF THE INVENTION

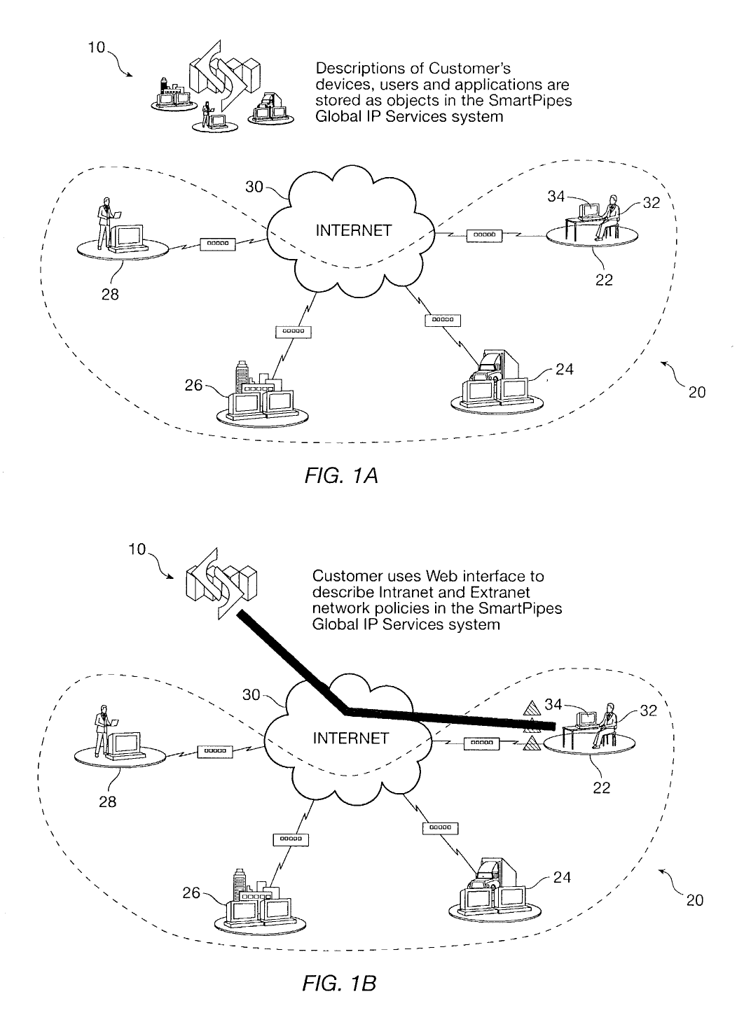

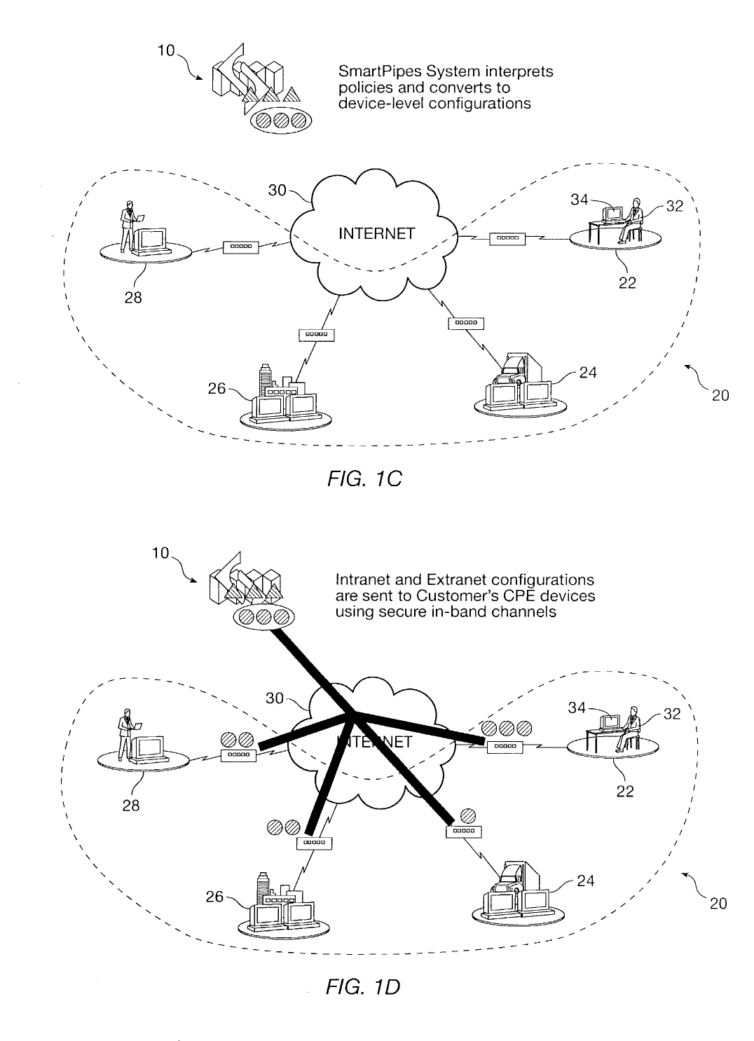

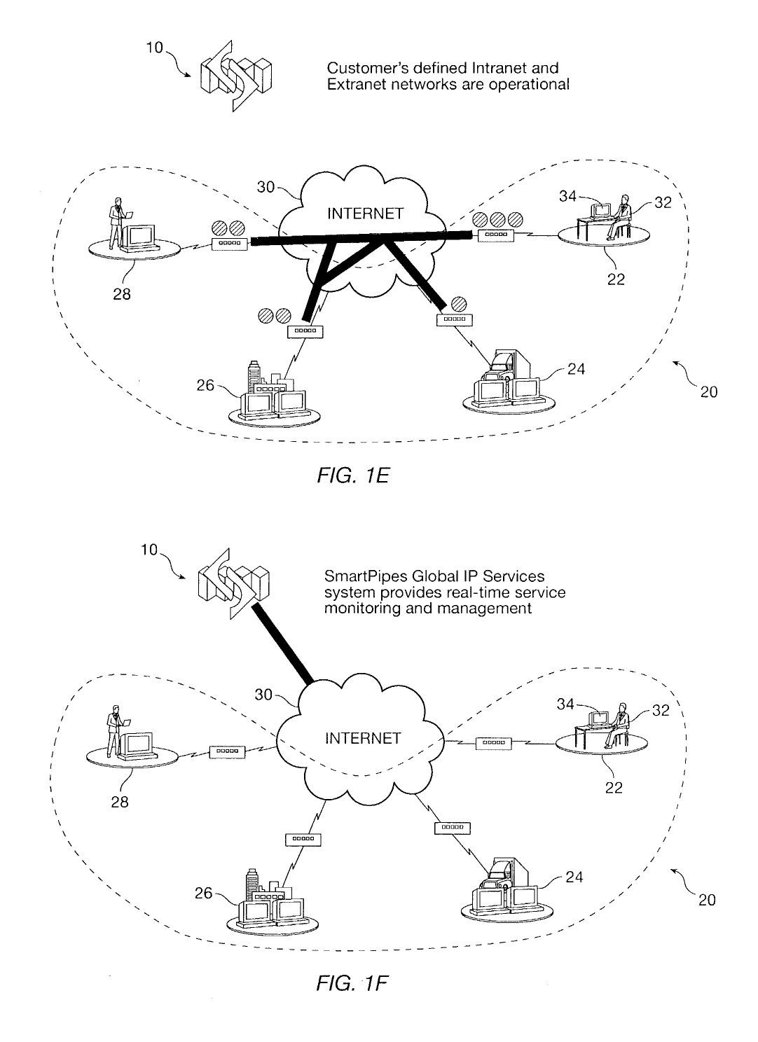

The present invention provides policy-based outsourced network management system at a service center and thus manages and controls a communication network having multiple network device types over a network (e.g., the internet). The management of a typical communications system by the outsourced management system of the present invention is briefly shown in FIGS. 1A-1F, described below.

FIG. 1A shows a customer communications network 20 (shown inside the dashed perimeter lines and composed of network, service points 22, 24, 26 and 28) that is coupled to the management system 10 via internet 30. Each network service point may include a number of network devices, such as routers, hubs, printers, facsimile machines, computer systems, etc. In FIG. 1A, internet 30 is shown as the communications medium via which customer 32 using his computer system 34 communicates with management system 10. The customer's devices are stored as objects in the management system 10.

Next, as shown in simplified FIG. 1B, the customer describes intranet and extranet policies for configuring the network communications system 20 under the control and management of system 10. Customer 32 uses a graphical user interface (GUI) on his/her computer system 34, such as an internet browser. The customer describes network policies using the browser, then provides them over the internet to management system 10.

Next, as shown in simplified FIG. 1C, system 10 interprets and converts the selected network policies to device-level configuration data and stores the configuration data in a directory.

Next, as shown in simplified FIG. 1D, system 10 via the internet 30 and using a secure channel, applies the selected intranet and extranet policies to configure the network devices disposed in each of the network service points 22, 24, 26, and 28 to thereby bring the communication network 20 under its control.

FIG. 1E shows that the system 10 has completed configuration of communications network 20, which therefore may carry out its intranet and extranet policies in accordance with the adopted policies.

FIG. 1F shows that after configuring the network devices and applying the network policies, system 10 continues to monitor and manage network communications system 20 via internet 30.

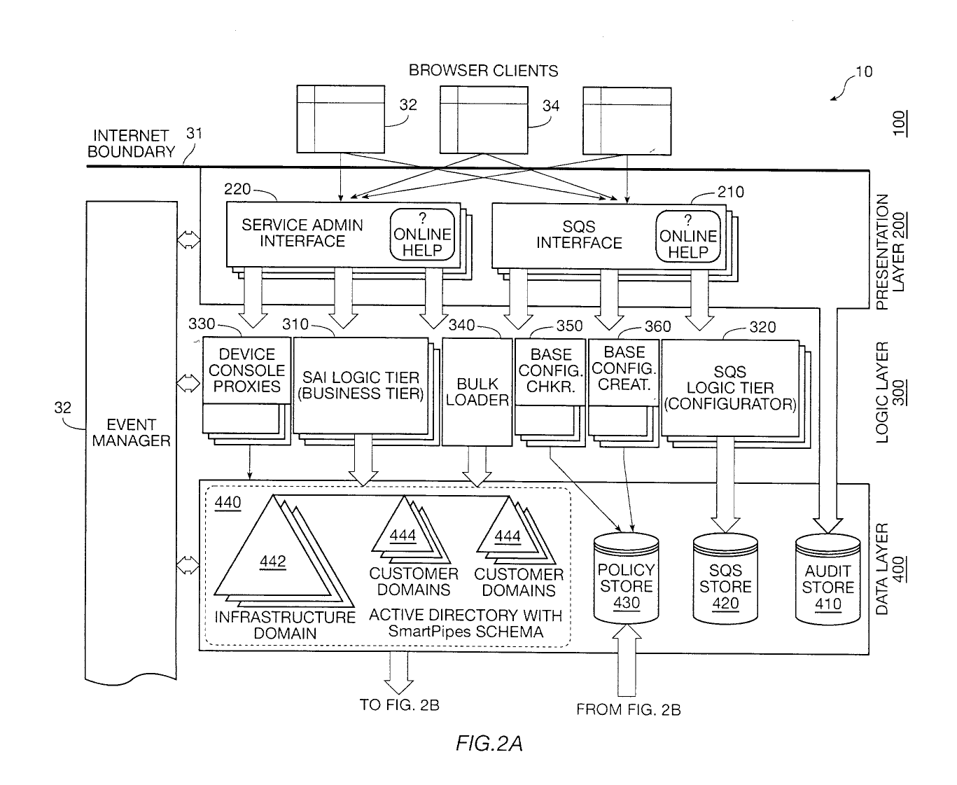

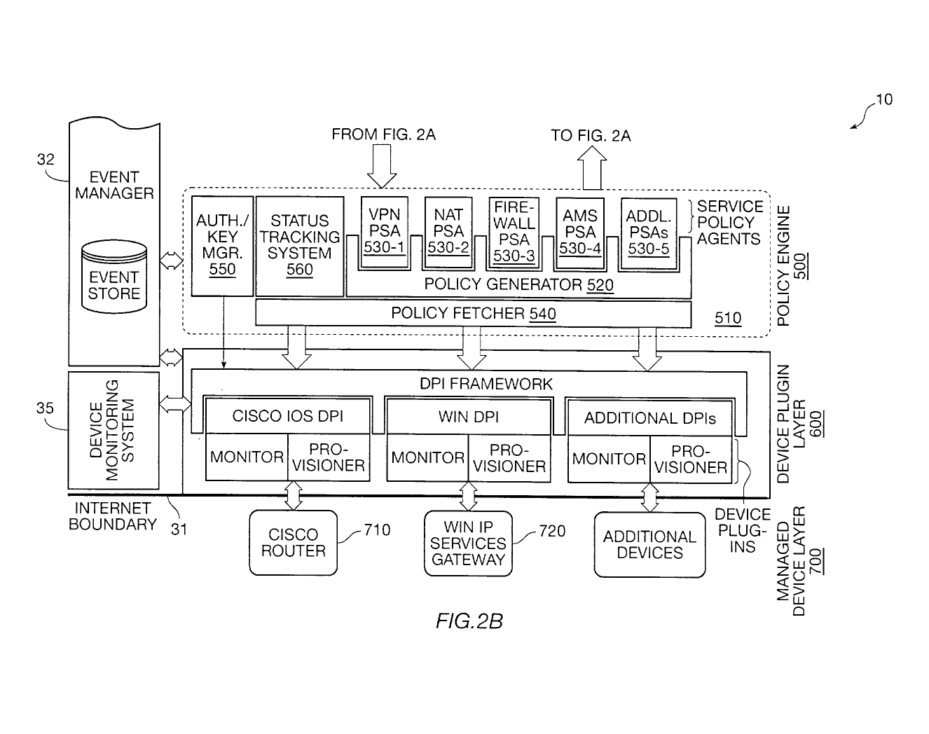

FIGS. 2A and 2B show simplified block diagrams of various layers of management system 10 of FIGS. 1A-IF, in accordance with one embodiment of the present invention. System 10 operates in accordance with a global policy service architecture and includes seven layers, namely, a client layer 100, a presentation layer 200, a logic layer 300, a data layer 400, a policy layer 500, a device plug-in layer 600 and a managed devices layer 700. System 10, also includes, among other modules, an event manager 32 and a device monitoring system 35. System 10 configures, monitors, and controls (i.e., manages) network devices, such as Cisco router 710 and Windows IP Services Gateway 720—in managed devices layer 700—via the internet 31.

System 10 provides a framework for describing internet protocol (IP) services by adopting network policies and managing the network devices (hereinbelow alternatively referred to as managed devices) in layer 700, in accordance with the adopted policies. System 10 is a data-center-based service architecture composed of an array of interacting software, network, and data store elements. System 10 is a dynamic, multi-layered, distributed architecture, and is secure and expandable.

To configure a network device and select and deploy network policies, a user first supplies information regarding his/her network devices (such as the devices' types, model numbers, IP addresses, base configuration data), as well other administrative information (e.g., a contact person at the user's company) to system 10 in one of the following two ways. The user may identify his/her network devices graphically and via an internet browser from various lists that system 10 displays to the user. System 10 collects the user data so identified and stores them in an XML file. Alternatively, the user may create an XML file containing such network identification data and transport that XML file directly to system 10 via the internet. It is understood that when a communication medium other than the internet is used, the user uses a GUI other than an internet browser and may use a file format other than the XML format. It is also understood that the user may create a file using a format other than the XML and which is directly viewable and transportable over the internet. The XML data identifying network devices—supplied by either of the above two methods—is subsequently converted to hierarchical data and written to an Active Directory™ 440.

Next, using a web browser, the user navigates through various policy lists—displayed to the user by system 10—from which lists the user selects and deploys network policies. The selected policy data are stored in Active Directory™ 440. Next, a policy engine in policy layer 500 retrieves policy data stored hierarchically in the Active Directory™ 440, knits different service-based policies together, converts the knitted policies from hierarchical to flat XML format, and thereafter stores the XML policy data which are service-based and device-neutral in policy store 430. Subsequently, an associated device plug-in residing in device plug-in layer 600 of system 10 receives the XML data—stored in the policy store—via the policy engine, translates the XML data to device-specific configuration data and, thereafter, transfers the device-specific configuration data to its associated network device thereby to configure the device and deploy the policies.

The policy generator 520 works with several Policy Service Agents (PSAs) to produce the network policy. The policy requirements received from the user are stored in an active directory 440, and are converted into flat XML file format by the PSAs, and thereafter are stored in a policy store 430. They are stored in an XML format that is non-device specific. The DPIs convert the non-device specific format into a device-specific format, and transmit over the internet to the customer devices. For example, a Cisco Router DPI 620 will convert the XML policy into a format specific to a Cisco Router, and transmit over the internet to the Cisco Router. Similarly, a Windows DPI 630 converts policy into a Windows-specific format.

The policies which are downloaded to the devices over the internet are done over a secure channel established over the internet. In one embodiment, this is an Internet Protocol SECurity (IPSec) protocol. Alternatively, or in addition, a Secure Sockets Layer (SSL) protocol may be used.

By making the system modular, the user can provide updates without needing to directly modify the stored policy. Similarly, the DPI interfaces can be modified, or new ones can be added, without modifying the policy engine and policy store. In addition, the policy engine and policy store can themselves be upgraded without affecting the interfaces to the customer or to the devices.

What is claimed is:

1. A method for remotely managing a network, comprising:
receiving a customer description of a desired customer network configuration over the internet;
automatically translating said customer description into device-level configuration data using software running at a service center; and
transmitting said device-level configuration data over the internet to devices of a network of said customer.

2. The method of claim 1 wherein said software running at a service center includes the following modules:
a policy generation layer that operates to generate policy in a non-device specific format; and
a device plug-in layer for converting policy from said policy generation layer into device specific format, and transmitting the converted policy to said devices of said network of said customer.

3. The method of claim 2 wherein said policy generation layer includes separate modules for generating policy for different types of policy, including a first module for virtual private networks (VPN) and a second policy for application management services (AMS) and a third module for security.

4. The method of claim 1 wherein said transmitting comprises using a secure in-band channel over the internet.

5. The method of claim 4 wherein said secure in-band channel is an IPSec tunnel.

6. The method of claim 1 wherein said configuration data comprises network policies.

7. The method of claim 6 wherein said network policies include intranet and extranet virtual private networks (VPNs).

8. The method of claim 1 wherein:
said customer description is translated into a device-neutral file;
said device neutral file is subsequently translated into a device-specific file.

9. The method of claim 8 wherein said device-neutral file is an XML file.

10. A method for configuring a network device, comprising:
establishing a secure communication link to said network device over a public network; and
downloading configuration information to said network device using said secure communication link over said public network.

11. The method of claim 10 wherein said public network is the internet.

12. The method of claim 10 wherein said secure communication link is an IPSec tunnel.

13. The method of claim 10 wherein said configuration information is a network policy.

14. The method of claim 13 wherein said network policy is a virtual private network (VPN) policy.

15. A method for configuring a network device, comprising:
establishing an IPSec tunnel to said network device over the internet; and
downloading virtual private network (VPN) policy configuration information to said network device using said IPSec tunnel over the internet.

16. The method of claim 15 wherein said network device is a router.

17. The method of claim 15 wherein said network device is an operating system.

18. A modular system for providing network management services over the internet, comprising:
a customer interface module for receiving customer inputs of network policy;
a policy generator module for converting said customer inputs into non-device specific format; and
a device plug-in module, for receiving said network policy in said non-device specific format, converting said policy into device specific format, and transmitting said policy to devices in a network of said customer.

19. The system of claim 18 wherein said non-device specific format is XML-based.
